(19) United States
(12) Patent Application Publication
(10) Pub. No.: US 2017/0192576 A1
(43) Pub. Date: Jul. 6, 2017

(54) FLEXIBLE GROMMET

(71) Applicant: Synaptics Incorporated, San Jose, CA (US)

(72) Inventors: Douglas M. Krumpelman, Coeur d'Alene, ID (US); Bic Schediwy, San Jose, CA (US)

(21) Appl. No.: 14/986,304

(22) Filed: Dec. 31, 2015

(51) Int. Cl. G06F 3/041; G06F 3/01

(52) U.S. Cl. CPC G06F 3/0414; G06F 3/0416; G06F 3/016; G06F 2203/04104

(57) ABSTRACT

An electronic system includes a housing and an input device configured to determine positional and force information from a plurality of input objects in a sensing region. The input device includes a rigid support substrate mechanically coupled to the housing, a force sensor coupled to an input surface, the input surface disposed above the rigid support substrate, and a coupling element disposed through an opening formed in the rigid support substrate. The coupling element is disposed between the housing and the rigid support substrate. The coupling element is also configured to allow the rigid support substrate to displace in a first direction relative to the housing on a plane of the input surface.

### FIELD

This invention generally relates to electronic devices.

### BACKGROUND

Input devices, including proximity sensor devices (also commonly called touchpads or touch sensor devices), are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

In general, in one aspect, one or more embodiments relate to an electronic system. The electronic system includes a housing and an input device configured to determine positional and force information from a plurality of input objects in a sensing region. The input device includes a rigid support substrate mechanically coupled to the housing, a force sensor coupled to an input surface, the input surface disposed above the rigid support substrate, and a coupling element disposed through an opening formed in the rigid support substrate. The coupling element is disposed between the housing and the rigid support substrate, and the coupling element is configured to allow the rigid support substrate to displace in a first direction relative to the housing on a plane of the input surface. The electronic system also includes a processing system communicatively coupled to the force sensor and configured to determine positional information and force information for the plurality of input objects and to actuate a haptic mechanism to translate the rigid support substrate in the first direction in response to a determined force applied by the plurality of input objects.

In general, in one aspect, one or more embodiments relate to an input device. The input device includes a rigid support substrate, a force sensor coupled to an input surface, the input surface disposed above the rigid support substrate, and a coupling element disposed through an opening formed in the rigid support structure. The coupling element is configured to allow the rigid support substrate to displace in a first direction on a plane of the input surface and configured to restrict displacement of the rigid support substrate in a second direction, wherein the second direction is perpendicular to the first direction.

Other aspects of the invention will be apparent from the following description and the appended claims.

### BRIEF DESCRIPTION OF DRAWINGS

The preferred exemplary embodiment of the present invention will hereinafter be described in conjunction with the appended drawings, where like designations denote like elements.

FIG. 1 is a block diagram of an example system that includes an input device in accordance with an embodiment of the invention.

FIG. 2 is a perspective view of an example input device in accordance with one or more embodiments of the invention.

FIG. 3A is a top view of a coupling element in accordance with one or more embodiments of the invention.

FIG. 3B is a side cross-sectional view of a coupling element in accordance with one or more embodiments of the invention.

FIG. 4A is a top view of a coupling element in accordance with one or more embodiments of the invention.

FIG. 4B is a side cross-sectional view of a coupling element in accordance with one or more embodiments of the invention.

FIG. 4C is a bottom cross-sectional view of a coupling element in accordance with one or more embodiments of the invention.

FIG. 5A is a perspective cross-sectional view of a coupling element in accordance with one or more embodiments of the invention.

FIG. 5B is a top view of a coupling element and a rigid support substrate in accordance with one or more embodiments of the invention.

### DETAILED DESCRIPTION

The following detailed description is merely exemplary in nature, and is not intended to limit the invention or the application and uses of the invention. Furthermore, there is no intention to be bound by any expressed or implied theory presented in the preceding technical field, background, brief summary or the following detailed description.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments of the present invention provide input devices and methods that facilitate improved usability. In particular, one or more embodiments of the invention are directed to mitigating effects of interference in capacitive sensing using profiles.

One or more embodiments may obtain capacitive sensor data by at least one transmitter electrode transmitting signals and resulting signals being received by a first set of sensor electrodes. A profile is obtained along the same axis as the first set of sensor electrodes. Using the profile, an interference measurement may be estimated and used to mitigate the effects of interference in the sensor data. Thus, positional information for an input object may be determined from the revised sensor data.

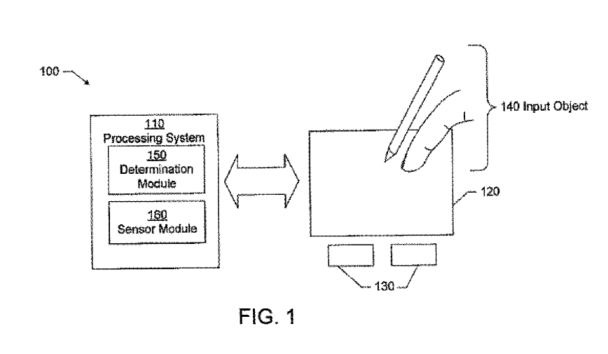

Turning now to the figures, FIG. 1 is a block diagram of an exemplary input device (100), in accordance with embodiments of the invention. The input device (100) may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device (100) and separate joysticks or key switches. Further example electronic systems include peripherals, such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device (100) may be implemented as a physical part of the electronic system, or may be physically separate from the electronic system. Further, portions of the input device (100) may be part of the electronic system. For example, all or part of the determination module may be implemented in the device driver of the electronic system. As appropriate, the input device (100) may communicate with parts of the electronic system using any one or more of the following: buses, networks, and other wired or wireless interconnections. Examples include I2C, SPI, PS/2, Universal Serial Bus (USB), Bluetooth, RF, and IRDA.

In FIG. 1, the input device (100) is shown as a proximity sensor device (also often referred to as a “touchpad” or a “touch sensor device”) configured to sense input provided by one or more input objects (140) in a sensing region (120). Example input objects include fingers and styli, as shown in FIG. 1. Throughout the specification, the singular form of input object is used. Although the singular form is used, multiple input objects may exist in the sensing region (120). Further, the particular input objects are in the sensing region may change over the course of one or more gestures. To avoid unnecessarily complicating the description, the singular form of input object is used and refers to all of the above variations.

The sensing region (120) encompasses any space above, around, in and/or near the input device (100) in which the input device (100) is able to detect user input (e.g., user input provided by one or more input objects (140)). The sizes, shapes, and locations of particular sensing regions may vary widely from embodiment to embodiment.

In some embodiments, the sensing region (120) extends from a surface of the input device (100) in one or more directions into space until signal-to-noise ratios prevent sufficiently accurate object detection. The extension above the surface of the input device may be referred to as the above surface sensing region. The distance to which this sensing region (120) extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device (100), contact with an input surface (e.g. a touch surface) of the input device (100), contact with an input surface of the input device (100) coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region (120) has a rectangular shape when projected onto an input surface of the input device (100).

The input device (100) may utilize any combination of sensor components and sensing technologies to detect user input in the sensing region (120). The input device (100) includes one or more sensing elements for detecting user input. As several non-limiting examples, the input device (100) may use capacitive, elastive, resistive, inductive, magnetic, acoustic, ultrasonic, and/or optical techniques.

Some implementations are configured to provide images that span one, two, three, or higher-dimensional spaces. Some implementations are configured to provide projections of input along particular axes or planes. Further, some implementations may be configured to provide a combination of one or more images and one or more projections.

In some resistive implementations of the input device (100), a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device (100), one or more sensing elements pick up loop currents induced by a resonating coil or pair of coils. Some combination of the magnitude, phase, and frequency of the currents may then be used to determine positional information.

In some capacitive implementations of the input device (100), voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects. The reference voltage may be a substantially constant voltage or a varying voltage and in various embodiments; the reference voltage may be system ground. Measurements acquired using absolute capacitance sensing methods may be referred to as absolute capacitive measurements.

Some capacitive implementations utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. The reference voltage may be a substantially constant voltage and in various embodiments; the reference voltage may be system ground. In some embodiments, transmitter sensor electrodes may both be modulated. The transmitter electrodes are modulated relative to the receiver electrodes to transmit transmitter signals and to facilitate receipt of resulting signals. A resulting signal may include effect(s) corresponding to one or more transmitter signals, and/or to one or more sources of environmental interference (e.g., other electromagnetic signals). The effect(s) may be the transmitter signal, a change in the transmitter signal caused by one or more input objects and/or environmental interference, or other such effects. Sensor electrodes may be dedicated transmitters or receivers, or may be configured to both transmit and receive. Measurements acquired using mutual capacitance sensing methods may be referred to as mutual capacitance measurements.

Further, the sensor electrodes may be of varying shapes and/or sizes. The same shapes and/or sizes of sensor electrodes may or may not be in the same groups. For example, in some embodiments, receiver electrodes may be of the same shapes and/or sizes while, in other embodiments, receiver electrodes may be varying shapes and/or sizes.

In FIG. 1, a processing system (110) is shown as part of the input device (100). The processing system (110) is configured to operate the hardware of the input device (100) to detect input in the sensing region (120). The processing system (110) includes parts of, or all of, one or more integrated circuits (ICs) and/or other circuitry components. For example, a processing system for a mutual capacitance sensor device may include transmitter circuitry configured to transmit signals with transmitter sensor electrodes, and/or receiver circuitry configured to receive signals with receiver sensor electrodes. Further, a processing system for an absolute capacitance sensor device may include driver circuitry configured to drive absolute capacitance signals onto sensor electrodes, and/or receiver circuitry configured to receive signals with those sensor electrodes. In one or more embodiments, a processing system for a combined mutual and absolute capacitance sensor device may include any combination of the above described mutual and absolute capacitance circuitry. In some embodiments, the processing system (110) also includes electronically-readable instructions, such as firmware code, software code, and/or the like. In some embodiments, components composing the processing system (110) are located together, such as near sensing element(s) of the input device (100). In other embodiments, components of processing system (110) are physically separate with one or more components close to the sensing element(s) of the input device (100), and one or more components elsewhere. For example, the input device (100) may be a peripheral coupled to a computing device, and the processing system (110) may include software configured to run on a central processing unit of the computing device and one or more ICs (perhaps with associated firmware) separate from the central processing unit. As another example, the input device (100) may be physically integrated in a mobile device, and the processing system (110) may include circuits and firmware that are part of a main processor of the mobile device. In some embodiments, the processing system (110) is dedicated to implementing the input device (100). In other embodiments, the processing system (110) also performs other functions, such as operating display screens, driving haptic actuators/mechanisms, etc.

The processing system (110) may be implemented as a set of modules that handle different functions of the processing system (110). Each module may include circuitry that is a part of the processing system (110), firmware, software, or a combination thereof. In various embodiments, different combinations of modules may be used. For example, as shown in FIG. 1, the processing system (110) may include a determination module (150) and a sensor module (160). The determination module (150) may include functionality to determine when at least one input object is in a sensing region, determine signal to noise ratio, determine positional information of an input object, identify a gesture, determine an action to perform based on the gesture, a combination of gestures or other information, and/or perform other operations.

The sensor module (160) may include functionality to drive the sensing elements to transmit transmitter signals and receive the resulting signals. For example, the sensor module (160) may include sensory circuitry that is coupled to the sensing elements. The sensor module (160) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Although FIG. 1 shows only a determination module (150) and a sensor module (160), alternative or additional modules may exist in accordance with one or more embodiments of the invention. Such alternative or additional modules may correspond to distinct modules or sub-modules than one or more of the modules discussed above. Example alternative or additional modules include hardware operation modules for operating hardware such as sensor electrodes and display screens, data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system as a whole may perform the operations of the various modules.

In some embodiments, the processing system (110) responds to user input (or lack of user input) in the sensing region (120) directly by causing one or more actions. Example actions include changing operation modes, as well as graphical user interface (GUI) actions such as cursor movement, selection, menu navigation, and other functions. In some embodiments, the processing system (110) provides information about the input (or lack of input) to some part of the electronic system (e.g. to a central processing system of the electronic system that is separate from the processing system (110), if such a separate central processing system exists). In some embodiments, some part of the electronic system processes information received from the processing system (110) to act on user input, such as to facilitate a full range of actions, including mode changing actions and GUI actions.

For example, in some embodiments, the processing system (110) operates the sensing element(s) of the input device (100) to produce electrical signals indicative of input (or lack of input) in the sensing region (120). The processing system (110) may perform any appropriate amount of processing on the electrical signals in producing the information provided to the electronic system. For example, the processing system (110) may digitize analog electrical signals obtained from the sensor electrodes. As another example, the processing system (110) may perform filtering or other signal conditioning. As yet another example, the processing system (110) may subtract or otherwise account for a baseline, such that the information reflects a difference between the electrical signals and the baseline. As yet further examples, the processing system (110) may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device (100) is implemented with additional input components that are operated by the processing system (110) or by some other processing system. These additional input components may provide redundant functionality for input in the sensing region (120), or some other functionality. FIG. 1 shows buttons (130) near the sensing region (120) that may be used to facilitate selection of items using the input device (100). Other types of additional input components include sliders, balls, wheels, switches, and the like. Conversely, in some embodiments, the input device (100) may be implemented with no other input components.

In some embodiments, the input device (100) includes a touch screen interface, and the sensing region (120) overlaps at least part of an active area of a display screen. For example, the input device (100) may include substantially transparent sensor electrodes overlaying the display screen and provide a touch screen interface for the associated electronic system. The display screen may be any type of dynamic display capable of displaying a visual interface to a user, and may include any type of light-emitting diode (LED), organic LED (OLED), cathode ray tube (CRT), liquid crystal display (LCD), plasma, electroluminescence (EL), or other display technology. The input device (100) and the display screen may share physical elements. For example, some embodiments may utilize some of the same electrical components for displaying and sensing. In various embodiments, one or more display electrodes of a display device may be configured for both display updating and input sensing. As another example, the display screen may be operated in part or in total by the processing system (110).

It should be understood that while many embodiments of the invention are described in the context of a fully-functioning apparatus, the mechanisms of the present invention are capable of being distributed as a program product (e.g., software) in a variety of foul's. For example, the mechanisms of the present invention may be implemented and distributed as a software program on information-bearing media that are readable by electronic processors (e.g., non-transitory computer-readable and/or recordable/writable information bearing media that is readable by the processing system (110)). Additionally, the embodiments of the present invention apply equally regardless of the particular type of medium used to carry out the distribution. For example, software instructions in the form of computer readable program code to perform embodiments of the invention may be stored, in whole or in part, temporarily or permanently, on a non-transitory computer-readable storage medium. Examples of non-transitory, electronically-readable media include various discs, physical memory, memory, memory sticks, memory cards, memory modules, and or any other computer readable storage medium. Electronically-readable media may be based on flash, optical, magnetic, holographic, or any other storage technology.

Although not shown in FIG. 1, the processing system, the input device, and/or the host system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores or micro-cores of a processor. Further, one or more elements of one or more embodiments may be located at a remote location and connected to the other elements over a network. Further, embodiments of the invention may be implemented on a distributed system having several nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While FIG. 1 shows a configuration of components, other configurations may be used without departing from the scope of the invention. For example, various components may be combined to create a single component. As another example, the functionality performed by a single component may be performed by two or more components.

One or more embodiments are directed to an electronic system. In one or more embodiments, the electronic system includes a housing and an input device configured to determine positional and force information from a plurality of input objects in a sensing region. In one or more embodiments, the input device includes a rigid support substrate mechanically coupled to the housing, a force sensor coupled to an input surface, the input surface disposed above the rigid support substrate, and a coupling element disposed through an opening formed in the rigid support substrate, in which the coupling element is disposed between the housing and the rigid support substrate, and in which the coupling element is configured to allow the rigid support substrate to displace in a first direction relative to the housing on a plane of the input surface. In one or more embodiments, the electronic system also includes a processing system communicatively coupled to the force sensor and configured to determine positional information and force information for the plurality of input objects and to actuate a haptic mechanism to translate the rigid support substrate in the first direction in response to a determined force applied by the plurality of input objects.

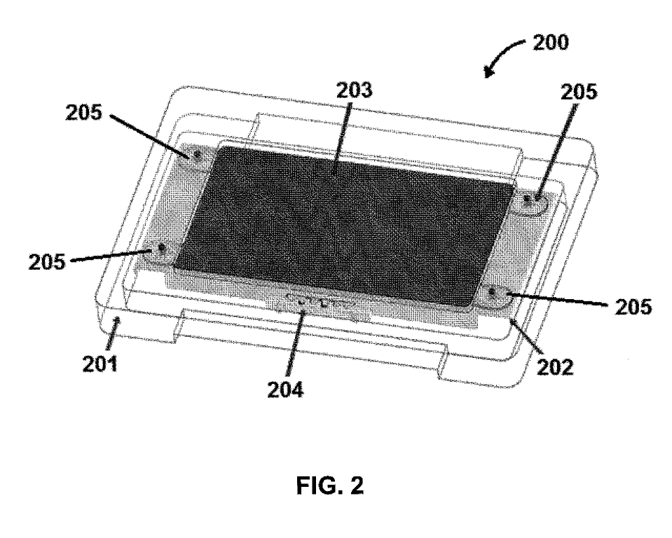

FIG. 2 shows a perspective view of an example input device (200) in accordance with one or more embodiments. In one or more embodiments, the input device (200) is configured to determine positional and force information from a plurality of input objects in a sensing region. As shown, the input device (200) includes a housing (201), a rigid support substrate (202), and an input surface (203). In one or more embodiments, the input surface (203) may be a sensing region and may be coupled to a force sensor, and the force sensor may be used to determine positional information and force information for a plurality of input objects on the input surface (203). In one or more embodiments, the force sensor includes one or more sensor electrodes and determines force applied by the input objects, e.g., the input objects (140) shown in FIG. 1, on the input surface (203). For more information on the force sensor, e.g., sensor electrodes, see FIG. 1 and the accompanying description.

In one or more embodiments, the input surface (203) may be flexible and may be disposed above the rigid support substrate (202), and the rigid support substrate (202) may be mechanically coupled to the housing (201) and may include one or more openings formed therethrough. Further, in one or more embodiments, one or more coupling elements (205) may be disposed through the openings of the rigid support substrate (202) and may be disposed between the housing (201) and the rigid support substrate (202). In other words, in one or more embodiments, the coupling elements (205) may be used to mechanically couple the rigid support substrate (202) to the housing (201). In one or more embodiments, each of the coupling elements (205) may be configured to allow the rigid support substrate (202) to displace in a first direction relative to the housing (201) on a plane of the input surface (203).

Further, in one or more embodiments, the input device (200) includes a haptic mechanism (204). In one or more embodiments, the haptic mechanism (204) may actuate in response to a position and/or force determined by the force sensor and the input surface (203). In one or more embodiments, the haptic mechanism (204) may be coupled to the rigid support substrate (202), and actuation of the haptic mechanism (204) may result in a force being applied to the rigid support substrate (202) by the haptic mechanism (204), e.g., in the first direction. As will be discussed further below, the coupling elements (205) may be used to allow displacement of the rigid support substrate (202) in a first direction relative to the housing (201), e.g., as a result of actuation of the haptic mechanism (204). As shown, in one or more embodiments, the coupling elements (205) may be positioned near corner portions and/or edge portions of the rigid support substrate (202), and openings may be formed in such portions of the rigid support substrate (202), accordingly.

In one or more embodiments, the electronic system also includes a processing system, e.g., the processing system (110) of FIG. 1, communicatively coupled to the force sensor and configured to determine positional information and force information for the plurality of input objects, e.g., the input objects (140) of FIG. 1, and to actuate the haptic mechanism (204) to translate the rigid support substrate (202) in the first direction in response to a determined force applied by the plurality of input objects (140).

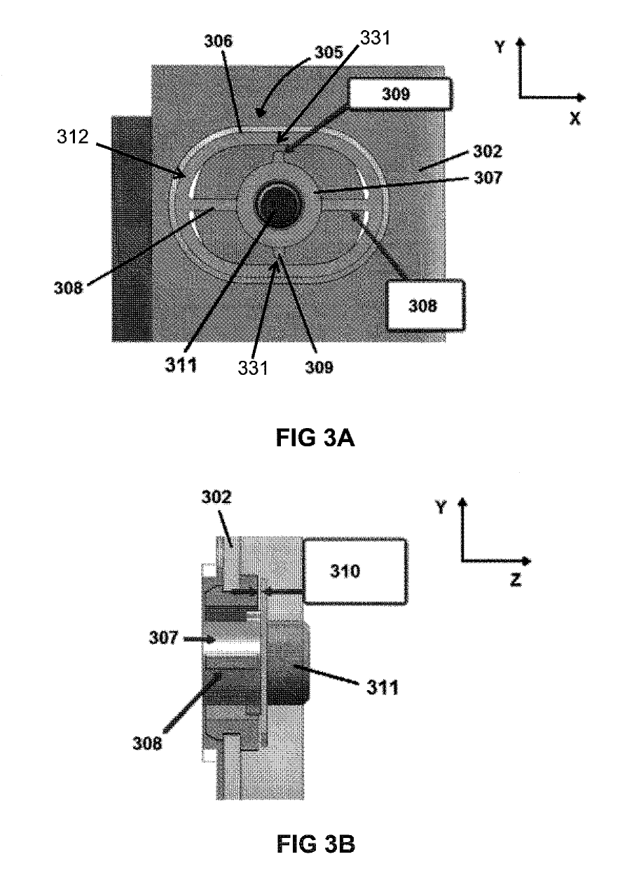

Referring now to FIGS. 3A and 3B, multiple views of a coupling element (305) in accordance with one or more embodiments is shown. As shown, the coupling element (305) may include a rigid grommet (306). In one or more embodiments, the rigid grommet (306) may be formed from a rigid material, e.g., metal, plastic, such as an injection moldable plastic, and may be engineered to hold parts rigidly in all directions except for a first direction, e.g., in the direction indicated by the arrow (Y). As shown, the rigid grommet (306) may include a central portion (307) having an opening formed therethrough and configured to receive a fixing member (311). In one or more embodiments, the fixing member (311) may be used to couple the coupling element (305) to one or more portions of the input device, e.g., to one or more portions of the input device (200) of FIG. 2. In one or more embodiments, the fixing member (311) may be used to restrict relative movement between the central portion (307) of the rigid grommet (306) and the housing of an input device, e.g., the housing (201) of the input device (200) shown in FIG. 2, in a first direction, a second direction, and/or a third direction.

As shown, the coupling element (305) includes internal webbing elements (308) disposed between the central portion (307) and an outer portion (312) of the rigid grommet (306). In one or more embodiments, the internal webbing elements (308) may be disposed on opposing sides of the central portion (307) and may be used to restrict displacement of the central portion (307) relative to the outer portion (312) of the rigid grommet (306) and also relative to a rigid support substrate (302) in one or more directions. For example, as shown, the internal webbing elements (308) are disposed along a second direction, e.g., in the direction indicated by the arrow (X). Because the internal webbing elements (308) are coupled to the central portion (307) and disposed along a second direction between the outer portion (312) and the central portion (307), the internal webbing elements (308) may restrict movement of the central portion (307) in the second direction relative to the outer portion (312) and also relative to the rigid support substrate (302). In other words, in one or more embodiments, the internal webbing elements (308) may extend between the central portion (307) and the outer portion (312) of the rigid grommet (306) in the direction indicated by the arrow (X), and displacement of the central portion (307) relative to the outer portion (312) and relative to the rigid support substrate (302) in the direction indicated by the arrow (X) is restricted. In one or more embodiments, the internal webbing (308) may be configured to restrict displacement of the rigid support substrate (302) relative to a housing of an input device, e.g., the housing (201) of the input device (200) shown in FIG. 2, in the second direction, e.g., in the direction indicated by the arrow (X).

In one or more embodiments, the outer portion (312) of the coupling element (305) may be coupled to the rigid support substrate (302) such that relative displacement between the outer portion (312) and the rigid support substrate (302) is restricted in a first direction, a second direction, and/or a third direction. However, in one or more embodiments, because the outer portion (312) of the rigid grommet (306) may displace relative to the central portion (307) of the rigid grommet (306) and vice versa, e.g., in the direction indicated by the arrow (Y), in one or more embodiments, the rigid support substrate (302) may also displace relative to the central portion (307) of the rigid grommet (306) and vice versa, e.g., in the direction indicated by the arrow (Y). Further, because the fixing member (311) may be used to restrict relative movement between the central portion (307) of the rigid grommet (306) and the housing of an input device, e.g., the housing (201) of the input device (200) shown in FIG. 2, both the central portion (307) of the rigid grommet (306) and the rigid support substrate (302) may also displace relative to the housing of the input device, e.g., in the direction indicated by the arrow (Y).

Further, as shown, the coupling element (305) includes displacement limiters (309) coupled to the central portion (307). In one or more embodiments, the displacement limiters (309) may be formed as portions of the central portion (307). As shown, gaps (331) may be formed between each of the displacement limiters (309) and the outer portion (312) of the rigid grommet (306). The gaps (331) may allow displacement of the central portion (307) relative to the outer portion (312) in a first direction, e.g., in the direction indicated by the arrow (Y). Although the gaps (331) may allow displacement of the central portion (307) relative to the outer portion (312) in the first direction, dimensions of the displacement limiters (309) may define the size of the gaps (331) and may limit the amount of displacement of the central portion (307) relative to the outer portion (312) in the first direction by abutting the rigid support substrate (302). As such, in one or more embodiments, the coupling element (305) may be coupled to both the rigid support substrate (302) and the housing, e.g., the housing (201) of the input device (200) shown in FIG. 2, and may be configured to allow the rigid support substrate (302) to displace in the first direction, e.g., in the direction indicated by the arrow (Y), relative to the housing on a plane of the input surface, e.g., on a plane of the input surface (203) shown in FIG. 2. As shown, in one or more embodiments, the first direction may be perpendicular to the second direction, and both the first direction and the second direction may be on a plane of the input surface.

In one or more embodiments, the internal webbing elements (308) of the coupling element (305) may provide a spring function for the rigid support substrate (302) in the first direction, e.g., in the direction indicated by the arrow (Y). For example, in one or more embodiments, the internal webbing elements (308) may be configured to maintain the outer portion (312) in an initial position, e.g., as shown in FIG. 3A, relative to the central portion (307). Although the gaps (331) may allow displacement of the central portion (307) relative to the outer portion (312) in a first direction, e.g., in the direction indicated by the arrow (Y), by an amount defined by the displacement limiters (309), the internal webbing elements (308) may provide a spring function for the rigid support substrate (302) and cause the outer portion (312) and the rigid support substrate (302) to return to the initial position relative to the central portion (307), e.g., as shown in FIG. 3A, despite any displacement of the central portion (307) in the first direction, e.g., in the direction indicated by the arrow (Y), relative to the outer portion (312) and/or the rigid support substrate (302) and vice versa. In other words, the internal webbing element (308) of the coupling element (305) may cause the rigid support substrate (302) to return to the initial position relative to the central portion (307) of the rigid grommet (306) after the rigid support substrate (302) after the rigid support substrate (302) is displaced in a first direction, e.g., in the direction directly opposite to the direction indicated by the arrow (Y), relative to the central portion (307) of the rigid grommet (306).

In one or more embodiments, the coupling element may include a washer, in which the washer configured to limit displacement of the rigid support substrate relative to the housing in a third direction. For example, as shown in FIG. 3B, the coupling element (305) may include a washer (310). In one or more embodiments, the washer (310) may limit displacement of the rigid support substrate (302) relative to the housing of an input device, e.g., the housing (201) of the input device (200) shown in FIG. 2, in the second direction, e.g., in the direction indicated by the arrow (Z). In one or more embodiments, the washer (310) may be used to reduce or minimize any gaps or space that may exist between the fixing element (311) and another portion of the coupling element (305). In one or more embodiments, the washer (310) may be used to reduce or minimize any gaps or space that may exist between the rigid grommet (306) and another portion of the housing of the input device. In one or more embodiments, the third direction, e.g., the direction indicated by the arrow (Z), extends along an axis that is orthogonal to the plane of the input surface, which, as discussed above, may include both the first direction, e.g., the direction indicated by the arrow (Y), and the second direction, e.g., the direction indicated by the arrow (X).

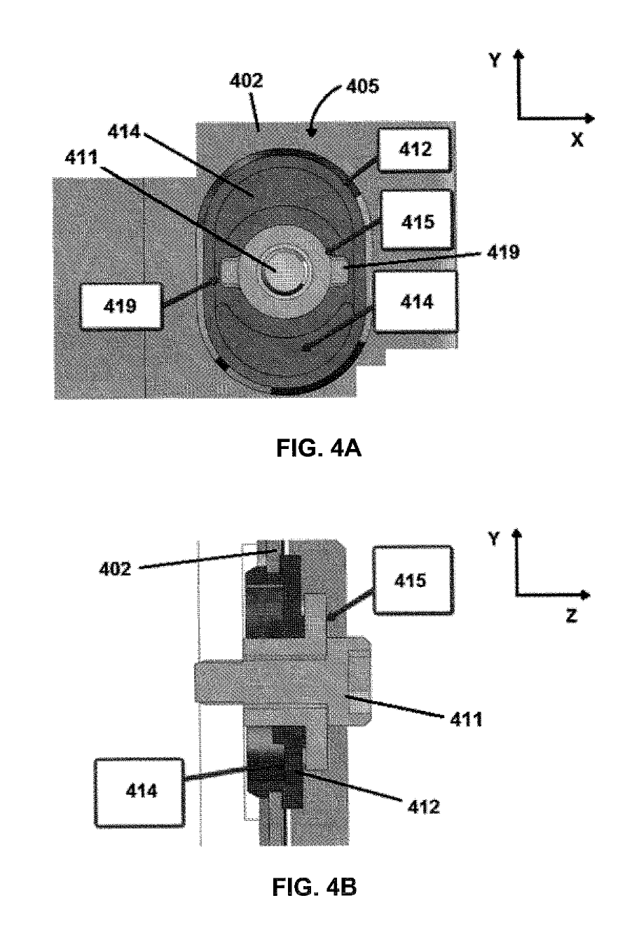

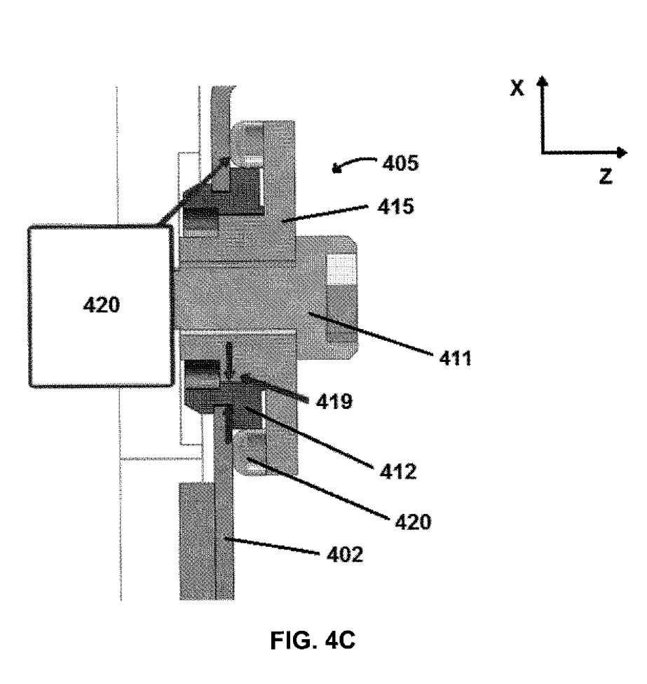

In one or more embodiments, the coupling element may include an elastomeric grommet. For example, referring now to FIGS. 4A-4C, multiple views of a coupling element (405) in accordance with one or more embodiments is shown. As shown, the coupling element (405) includes an elastomeric grommet (412) and central mounting hardware (415) disposed within and coupled to the elastomeric grommet (412). In one or more embodiments, the central mounting hardware (415) may be formed from a rigid material, e.g., metal, plastic, such as an injection moldable plastic, and may be engineered to hold parts rigidly in all directions, and the elastomeric grommet (412) may be formed from an elastomeric material that may allow the central mounting hardware (415) to displace within the elastomeric grommet (412). In one or more embodiments, the central mounting hardware (415) may have an opening formed therethrough and may be configured to receive a fixing member (411). In one or more embodiments, the fixing member (411) may be used to couple the central mounting hardware (415) to one or more portions of the input device, e.g., to one or more portions of the input device (200) of FIG. 2, such as a housing.

In one or more embodiments, the elastomeric grommet (412) may be disposed within an opening formed in a rigid support substrate (402). In one or more embodiments, the opening formed in the rigid support substrate (402) through which the coupling element is disposed may be obround in shape. This obround shape may allow the central mounting hardware (415) coupled to the elastomeric grommet (412) to displace relative to the rigid support substrate (402) and vice versa in at least one direction. In one or more embodiments, the obround shape of the opening formed in the rigid support substrate (402) through which the coupling element (405) is disposed may extend further in a first direction, e.g., in the direction of the arrow (Y), than in a second direction, e.g., in the direction of the arrow (X). In other words, in one or more embodiments, the obround shape of the opening formed in the rigid support substrate (402) through which the coupling element (405) is disposed may allow more displacement of the central mounting hardware (415) relative to the rigid support substrate (402) and vice versa in the first direction, e.g., in the direction of the arrow (Y), than in a second direction, e.g., in the direction of the arrow (X).

In one or more embodiments, the elastomeric grommet (412) may provide a spring function for the rigid support substrate (402) in the first direction, e.g., in the direction of the arrow (Y). Further, in one or more embodiments, the elastomeric grommet (412) may provide a spring function for the rigid support substrate (402) in the second direction, e.g., in the direction of the arrow (X), and cause the rigid support substrate (402) to return to the initial position relative to the central mounting hardware (415), e.g., as shown in FIG. 4A, despite any displacement of the central mounting hardware (415) in the first direction, e.g., in the direction indicated by the arrow (Y), relative to the rigid support substrate (402) and vice versa.

In one or more embodiments, the elastomeric grommet (412) may also include cutaways (414) to provide compliance in the first direction, e.g., in the direction of the arrow (Y), for the central mounting hardware (415). In one or more embodiments, the cutaways (414) may be portions of the elastomeric grommet (412) that are either reduced in thickness, e.g., reduced in a direction of the arrow (Z), relative to portions of the elastomeric grommet (412) that are directly adjacent the central mounting hardware (415) or that are removed from the elastomeric grommet (412). Such configurations of the elastomeric grommet (412) may reduce a biasing force or resistance by the elastomeric grommet (412) that may bias the rigid support substrate (402) towards the initial position, e.g., as shown in FIG. 4A, relative to the central mounting hardware (415) and vice versa.

In one or more embodiments, the coupling element (405) also includes a plurality of displacement limiters (419), (420) of the central mounting hardware (415) disposed on opposite sides of the central mounting hardware (415). In one or more embodiments, the displacement limiters (419), (420) may be formed as portions of the central mounting hardware (415).

For example, as shown in FIG. 4A, the plurality of displacement limiters (419) are disposed on opposite sides of the central mounting hardware (415) and are configured to limit displacement of the rigid support substrate (402) relative to the housing in a second direction, e.g., in the direction of the arrow (X). For example, although a width of the opening, e.g., an obround or elliptical opening, formed in the rigid support substrate (402) through which the elastomeric grommet (412) is disposed may allow for the central mounting hardware (415) to displace relative to the rigid support substrate (402), the displacement limiters (419) may limit the displacement of the central mounting hardware (415) relative to the rigid support substrate (402) by abutting the rigid support substrate (402). Further, as shown in FIG. 4C, the plurality of displacement limiters (420) are disposed on opposite sides of the central mounting hardware (415) and are similarly configured to limit displacement of the rigid support substrate (402) relative to the housing in a third direction, e.g., in the direction of the arrow (Z), e.g., by abutting the rigid support substrate (402).

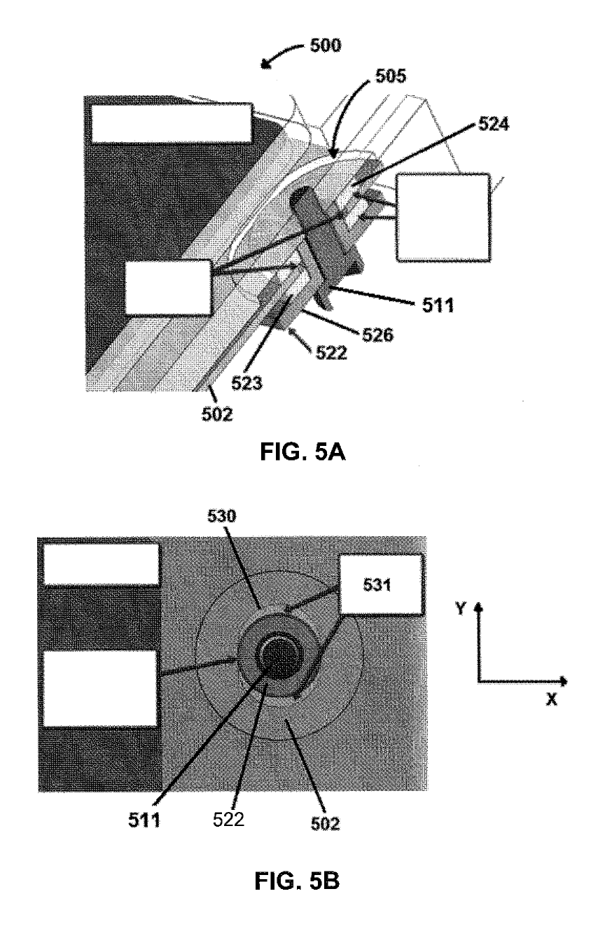

Referring now to FIGS. 5A and 5B, multiple views of a coupling element (505) of an input device (500) are shown. As shown, the coupling element (505) includes a flanged washer (522) having a flange (526) formed thereon. In one or more embodiments, the flanged washer (522) may have an opening formed therethrough and may be configured to receive a fixing member (511). In one or more embodiments, the fixing member (511) may be used to couple the coupling element (505) to one or more portions of the input device, e.g., to one or more portions of the input device (200) of FIG. 2. In one or more embodiments, the fixing member (511) may be used to restrict relative movement between the flanged washer (522) and the housing of an input device, e.g., the housing (201) of the input device (200) shown in FIG. 2, in a first direction, a second direction, and/or a third direction.

FIG. 5B shows an example embodiment of an obround opening (530) formed in the rigid support substrate (502) discussed above. As shown, displacement of the rigid support substrate (502) relative to the housing of the input device may be determined by the obround shape of the opening (530) formed in the rigid support structure (502). For example, displacement of the rigid support substrate (502) relative to the housing of the input device may be limited in a first direction, e.g., in a direction of the arrow (Y), and may be restricted in a second direction, e.g., in a direction of the arrow (X). This limitation and restriction of movement may be determined by the obround shape of the opening (530). As shown, the obround shape of the opening (530) may not necessarily allow any gaps or space to be formed on either side of the flanged washer (522) in the direction of the arrow (X). However, as shown, gaps (531) may be formed on either side of the flanged washer (522) in the direction of the arrow (Y). As such, in one or more embodiments, because the housing of the input device may be fixed to the flanged washer (522) by way of the fixing member (511), the obround shape of the opening (530) may allow for limited displacement of the rigid support substrate (502) relative to the housing of the input device and vice versa in the first direction, e.g., in the direction of the arrow (Y), and may restrict displacement of the rigid support substrate (502) relative to the housing of the input device and vice versa in the second direction, e.g., in the direction of the arrow (X).

Returning to FIG. 5A, in one or more embodiments, the coupling element (505) includes a first elastomeric washer (523) disposed between a rigid support substrate (502) and the flange (526) of the flanged washer (522). In one or more embodiments, the first elastomeric washer (523) may be formed from an elastomeric material and may be mounted to the flange (526) of the flanged washer (522) with an adhesive material. In one or more embodiments, the coupling element (505) also may include a second elastomeric washer (524) mounted to the rigid support substrate (502) with an adhesive material. In one or more embodiments, displacement of the rigid support substrate (502) in a third direction may be limited by the first elastomeric washer (523), in which the third direction extends along an axis that is orthogonal to the plane of the input surface, as discussed above. Further, in one or more embodiments, displacement of the rigid support substrate (502) in the third direction may also be limited by the second elastomeric washer (524). In one or more embodiments, the displacement of the rigid support substrate (502) relative to the housing of an input device, e.g., the housing (201) of the input device (200) shown in FIG. 2, in the third direction may be limited but not necessarily restricted due to the elasticity of both the first elastomeric washer (523) and the second elastomeric washer (524). In other words, in one or more embodiments, force applied to an input surface, e.g., the input surface (120) of FIG. 1, of the input device may cause the rigid support substrate to be forced in the third direction, in which both the first elastomeric washer (523) and the second elastomeric washer (524) may limit the displacement of the rigid support substrate (502) relative to the housing of an input device, e.g., by way of surface area of the first elastomeric washer (523) and the second elastomeric washer (524). Furthermore, in one or more embodiments, the rigid support substrate (502) may be held at a constant electric potential and may shield a force sensor, e.g., one or more sensor electrodes discussed in FIG. 1, from noise.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

Thus, while the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An electronic system comprising:
a housing;
an input device configured to determine positional and force information from a plurality of input objects in a sensing region, the input device comprising:
a rigid support substrate mechanically coupled to the housing;
a force sensor coupled to an input surface, the input surface disposed above the rigid support substrate; and
a coupling element disposed through an opening formed in the rigid support substrate, wherein the coupling element is disposed between the housing and the rigid support substrate, and wherein the coupling element is configured to allow the rigid support substrate to displace in a first direction relative to the housing on a plane of the input surface; and
a processing system communicatively coupled to the force sensor and configured to determine positional information and force information for the plurality of input objects and to actuate a haptic mechanism to translate the rigid support substrate in the first direction in response to a determined force applied by the plurality of input objects.

2. The electronic system of claim 1, wherein coupling element is formed from plastic.

3. The electronic system of claim 2, wherein the coupling element comprises a central portion and internal webbing disposed on opposite sides of the central portion, the internal webbing configured to restrict displacement of the rigid support substrate relative to the housing in a second direction.

4. The electronic system of claim 3, wherein the internal webbing of the coupling element provides a spring function for the rigid support substrate in the first direction.

5. The electronic system of claim 3, wherein the first direction is perpendicular to the second direction.

6. The electronic system of claim 3, wherein the coupling element comprises a plurality of displacement limiters, the plurality of displacement limiters disposed on opposite sides of the central portion, and the plurality of displacement limiters configured to limit displacement of the rigid support substrate relative to the housing in the first direction.

7. The electronic system of claim 1, wherein the coupling element comprises a washer, the washer configured to limit displacement of the rigid support substrate relative to the housing in a third direction, wherein the third direction extends along an axis that is orthogonal to the plane of the input surface.

8. The electronic system of claim 1, wherein the coupling element comprises an elastomeric grommet.

9. The electronic system of claim 8, wherein the coupling element comprises central mounting hardware disposed within the elastomeric grommet, wherein the central mounting hardware is rigid and is coupled to the housing.

10. The electronic system of claim 9, further comprising a plurality of displacement limiters of the central mounting hardware disposed on opposite sides of the central mounting hardware, the plurality of displacement limiters configured to limit displacement of the rigid support substrate relative to the housing in a second direction and in a third direction.

11. The electronic system of claim 8, wherein the elastomeric grommet provides a spring function for the rigid support substrate in the first direction.

12. The electronic system of claim 1, wherein the opening formed in the rigid support substrate through which the coupling element is disposed is obround in shape.

13. The electronic system of claim 12, wherein the coupling element comprises a flanged washer having a flange formed thereon.

14. The electronic system of claim 13, wherein the coupling element comprises a first elastomeric washer disposed between the rigid support substrate and the flange of the flanged washer.

15. The electronic system of claim 14, wherein the first elastomeric washer is mounted to the flange of the flanged washer with an adhesive material.

16. The electronic system of claim 15, wherein the coupling element comprises a second elastomeric washer mounted to the rigid support substrate with an adhesive material.

17. The electronic system of claim 14, wherein displacement of the rigid support substrate relative to the housing is allowed in the first direction and restricted in a second direction.

18. The electronic system of claim 17, wherein displacement of the rigid support substrate relative to the housing is determined by the obround shape of the opening formed in the rigid support structure.

19. The electronic system of claim 14, wherein displacement of the rigid support substrate in a third direction is limited by the first elastomeric washer, wherein the third direction extends along an axis that is orthogonal to the plane of the input surface.

20. The electronic system of claim 1, wherein the rigid support substrate is held at a constant electric potential and shields the force sensor from noise.

21. An input device comprising:
a rigid support substrate;
a force sensor coupled to an input surface, the input surface disposed above the rigid support substrate; and
a coupling element disposed through an opening formed in the rigid support structure, wherein the coupling element is configured to allow the rigid support substrate to displace in a first direction on a plane of the input surface and configured to restrict displacement of the rigid support substrate in a second direction, wherein the second direction is perpendicular to the first direction.
